(19) United States
(12) Patent Application Publication
(10) Pub. No.: US 2010/0238579 A1
(43) Pub. Date: Sep. 23, 2010

(54) MAGNETIC STORAGE DEVICE, METHOD FOR SETTING PROCESSING CONDITIONS FOR MAGNETIC STORAGE DEVICE, AND COMPUTER PROGRAM PRODUCT FOR SETTING PROCESSING CONDITIONS FOR MAGNETIC STORAGE DEVICE

(75) Inventor: Masaki SAITO, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/728,079

(22) Filed: Mar. 19, 2010

(30) Foreign Application Priority Data
Mar. 19, 2009 (JP) 2009-068387

(51) Int. Cl. G11B 5/09

(52) U.S. Cl. 360/53; G9B/5.033

(57) ABSTRACT

According to one embodiment, a magnetic storage device, includes: a verification processing detector configured to detect whether there are a plurality of operation commands corresponding to a first verifying operation, based on a plurality of sets of individual information about the operation commands for the magnetic storage device from an external device, the sets of individual information including execution times and sets of accessed address information, the sets of individual information being stored in a first storage module as history information; and a processing condition setting module configured to set processing conditions for a second verifying operation to verify data stored in the first storage module, based on the sets of individual information corresponding to the first verifying operation, when the operation commands are detected.

### CROSS-REFERENCE TO RELATED APPLICATIONS

This application is based upon and claims the benefit of priority from Japanese Patent Application No. 2009-068387, filed Mar. 19, 2009, the entire contents of which are incorporated herein by reference.

### BACKGROUND

1. Field

One embodiment of the invention relates to a magnetic storage device in which a verifying operation to verify the data stored in a storage module by an external device is performed on regular basis, a method for setting processing conditions for the magnetic storage device, and a computer program product for setting processing conditions for the magnetic storage device.

2. Description of the Related Art

Conventionally, a magnetic storage device has a function to record operation commands (hereinafter referred to as “commands”) received from a host device as history information. The contents to be recorded comprises the reception time of each command, the execution time and completion time of each command, and the data structure observed when each command is received from the host device. Those contents are stored in a HDD or the like in chronological order of command execution. In an idle state where there are no commands from the host device over a predetermined period of unit time, the magnetic storage device performs an off-line medium verifying operation (hereinafter, referred to as a background media scan (BMS) operation). The operation performs a so-called media scan to sequentially read the media from the top area through the last area of the storage area in the HDD. Through this operation, defective sectors can be detected in early stages, and precaution measures can be taken against the defective sectors. In a computer system having a large-scale external storage device, the host device that manages and controls the external storage device also regularly performs a patrolling operation on the magnetic storage device forming the external storage device. The operation is performed as a sequential READ operation to perform media reading sequentially from the top area or an intermediate area of the storage area in the HDD, or as a sequential VERIFY operation to verify data errors sequentially from the top area or an intermediate area of the storage area in the HDD. The operation is realized by the computer system issuing commands on a regular basis while the host device is performing data reading or writing on the external storage device.

For example, Japanese Patent Application Publication (KOKAI) Nos. 2006-285807 and H05-224830 disclose techniques related to magnetic storage devices.

When a new command is input from a host device during the BMS operation, a magnetic storage device immediately ends the BMS operation, and moves on to an operation to execute the input command. There is a difference in the time required to move on to the execution of the command between a case where a BMS operation is not being performed and the device is in a normal operating state, and a case where a BMS operation is being performed. Where a BMS operation is being performed, it is difficult to move on to execution of the new command more quickly than in the normal operation or in the same period of time as in the normal operation, since the BMS operation is also being performed. Therefore, a response to the command issued from the host device delays in the case where the BMS operation is being performed, compared with a response in the normal operation. As the frequency of BMS operations becomes higher, the time required to send a response to a command issued from the host device becomes longer, and the performance of the magnetic storage device as the external storage device is degraded. Also, since data reading operation and writing operation are performed on the HDD, the components of the HDD, recording disk media, and the head deteriorate at least to some degree, because the usage frequency of those components becomes higher. Therefore, if data reading operation and writing operation are performed over a longer period of time, the life of the HDD becomes shorter. In the magnetic storage device, the rules for completing the BMS operations on the entire data stored in the HDD within a predetermined period of time are set. As a result, patrolling operations that are performed on a regular basis overlap the BMS operations. In view of this, the magnetic storage device is expected to efficiently perform BMS operations.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a magnetic storage device according to an embodiment of the invention;

FIG. 2 is another exemplary block diagram of the magnetic storage device in the embodiment;

FIG. 3 is an exemplary diagram of individual information about a command in the embodiment;

FIG. 4 is an exemplary diagram of a command log in the embodiment;

FIG. 5 is an exemplary flowchart of a BMS setting operation to be performed in a magnetic storage device in the embodiment;

FIG. 6 is an exemplary search table in the embodiment;

FIG. 7 is an exemplary diagram of individual information about READ commands to be registered in a search table in the embodiment;

FIG. 8 is an exemplary search table having READ #S0 registered therein, in the embodiment;

FIG. 9 is another exemplary search table having READ #R0a registered therein, in the embodiment;

FIG. 10 is still another exemplary search table having READ #R1 registered therein, in the embodiment;

FIG. 11 is still another exemplary search table having READ #S1 registered therein, in the embodiment;

FIG. 12 is still another exemplary search table having READ #R2 registered therein, in the embodiment;

FIG. 13 is still another exemplary search table having READ #R0b registered therein, in the embodiment;

FIG. 14 is still another exemplary search table having READ #R0c registered therein, in the embodiment;

FIG. 15 is still another exemplary search table having READ #S2 registered therein, in the embodiment;

FIG. 16 is still another exemplary search table having READ #S3 registered therein, in the embodiment;

FIG. 17 is still another exemplary search table having READ #R3a registered therein, in the embodiment;

FIG. 18 is still another exemplary search table having READ #R3b registered therein, in the embodiment;

FIG. 19 is an exemplary flowchart of a determining operation to be performed in a magnetic storage device in the embodiment;

FIG. 20 is an exemplary flowchart of an individual information adding operation to be performed in a magnetic storage device in the embodiment;

FIG. 21 is an exemplary flowchart of a first extracting operation to be performed in a magnetic storage device in the embodiment;

FIG. 22 is an exemplary flowchart of a second extracting operation to be performed in a magnetic storage device in the embodiment;

FIG. 23 is an exemplary diagram for explaining a BMS operation having processing conditions set through a setting operation in the embodiment; and

FIG. 24 is an exemplary schematic diagram of a computer system in the embodiment.

### DETAILED DESCRIPTION

Various embodiments according to the invention will be described hereinafter with reference to the accompanying drawings. In general, according to one embodiment of the invention, a magnetic storage device, comprises: a verification processing detector configured to detect whether there are a plurality of operation commands corresponding to a first verifying operation, based on a plurality of sets of individual information about the operation commands for the magnetic storage device from an external device, the sets of individual information comprising execution times and sets of accessed address information, the sets of individual information being stored in a first storage module as history information; and a processing condition setting module configured to set processing conditions for a second verifying operation to verify data stored in the first storage module, based on the sets of individual information corresponding to the first verifying operation, when the operation commands are detected.

According to another embodiment of the invention, a method for setting processing conditions for a magnetic storage device, the method comprises: detecting whether there are a plurality of operation commands corresponding to a first verifying operation, based on a plurality of sets of individual information about the operation commands for the magnetic storage device from an external device, the sets of individual information comprising execution times and sets of accessed address information, the sets of individual information being stored in a first storage module as history information; and when the operation commands are detected, setting processing conditions for a second verifying operation to verify data stored in the first storage module, based on the sets of individual information corresponding to the first verifying operation.

According to still another embodiment of the invention, a computer program product for setting processing conditions for a magnetic storage device, the product having a computer readable medium including programmed instructions that, when executed by a computer, cause the computer to perform, detecting whether there are a plurality of operation commands corresponding to a first verifying operation, based on a plurality of sets of individual information about the operation commands for the magnetic storage device from an external device, the sets of individual information comprising execution times and sets of accessed address information, the sets of individual information being stored in a first storage module as history information; and when the operation commands are detected, setting processing conditions for a second verifying operation to verify data stored in the first storage module, based on the sets of individual information corresponding to the first verifying operation.

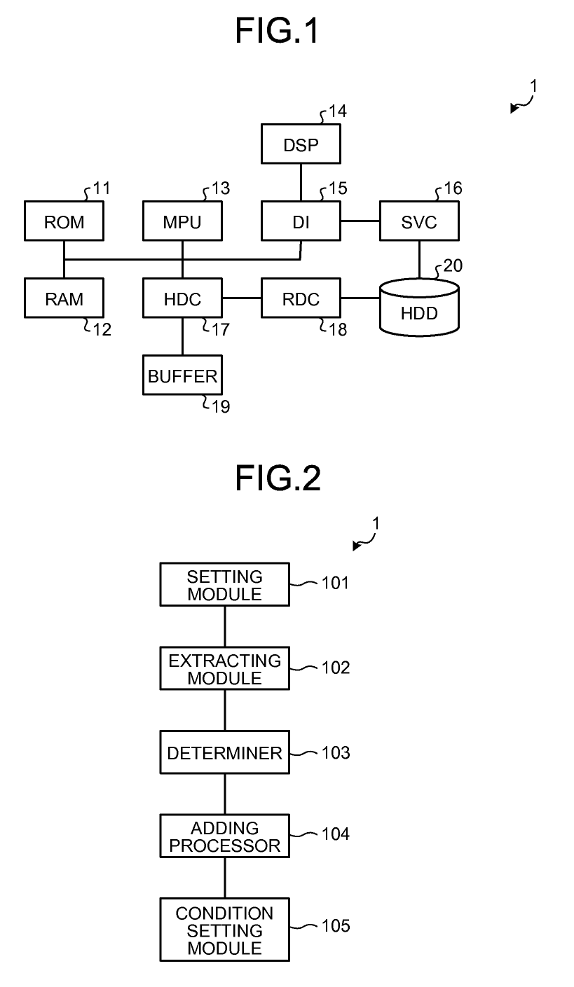

Referring to FIG. 1, the structure of a magnetic storage device according to an embodiment is described. As illustrated in FIG. 1, a magnetic storage device 1 comprises a Read Only Memory (ROM) 11, a Random Access Memory (RAM) 12, a Micro Processing Unit (MPU) 13, a Digital Signal Processor (DSP) 14, a drive Interface (DI) 15, a Servo Controller (SVC) 16, a Hard Disk Controller (HDC) 17, a Read Write Channel (RDC) 18, a buffer 19, and a Hard Disk Drive (HDD) (the first storage module) 20.

The ROM 11 is a nonvolatile storage area that stores the firmware program of the magnetic storage device (hereinafter referred to as the “device control FW”), the firmware program for controlling the drive (hereinafter referred to as the “drive control FW”), and the likes. The RAM 12 is a volatile storage area that stores variable data and the likes to be used during an operation of the device control RW. The MPU 13 and the DSP 14 control the RDC 18 and the SVC 16 in accordance with an instruction from the HDC 17. The DI 15 sets the register for communications between the device control FW and the drive control FW. The SVC 16 performs servo control on the HDD 20. The HDC 17 performs a communication with a host device via an interface (not illustrated) such as a small computer system interface (SCSI), receives a command from the host device, and sends an instruction to the MPU 13. The RDC 18 encodes data to be written into the HDD 20, and decodes signals of data read from the HDD 20. The buffer 19 is a storage area formed with a data storable RAM, and temporarily stores data that is read from the HDD 20 via the RDC 18, and data that is transferred from the host device via the HDC 17 and is to be written into the HDD 20. The HDD 20 is a nonvolatile storage area that stores data that is read or written by the host device. The DI 15, the SVC 16, the HDC 17, and the RDC 18 constitute a custom Large Scale Integration (LSI). The MPU 13 may be a Central Processing Unit (CPU).

FIG. 2 is a functional block diagram of the magnetic storage device according to the embodiment. As illustrated in FIG. 2, the magnetic storage device 1 comprises a setting module 101, an extracting module 102, a determiner 103, an adding processor 104, and a condition setting module 105. The setting module 101 sets the later described search table. The extracting module 102 extracts a predetermined command from a command log that is the stored data of the history information about a plurality of commands received in a unit time (a predetermined period of time). The commands are issued from the host to the magnetic storage device 1, and are stored in the HDD 20. The unit time may be arbitrarily set as 24 hours, 48 hours, or the like. Alternatively, the unit time may be set as the period of time between the time when the previous BMS operation (a second verifying operation) is performed and the present time. The conditions for extracting the predetermined command from the command log may be arbitrarily set by an interface command in accordance with the device usage environment or the like. For example, where commands used to read data (hereinafter referred to as the “READ command”) are set as the subjects to be extracted, commands used to verify data (hereinafter referred to as the “VERIFY command”) can be set as the subjects to be extracted. In the embodiment, the READ commands in the command log of the last 24 hours are set as the subjects to be extracted. The determiner 103 determines whether there are commands other than the commands extracted by the extracting module 102. The determiner 103 also determines whether there is individual information about the commands in a patrolling operation (a first verifying operation) in the search table, and stores the determination result into the buffer 19 or the HDD 20. The individual information about the commands will be described later. The adding processor 104 performs an individual information adding operation. The command adding operation will be described later. The setting module 101, the extracting module 102, the determiner 103, and the adding processor 104 perform the later described determining operation. The condition setting module 105 performs the later described setting operation. The functional blocks are realized by the hardware resources such as the ROM 11 and the MPU 13 cooperating with software.

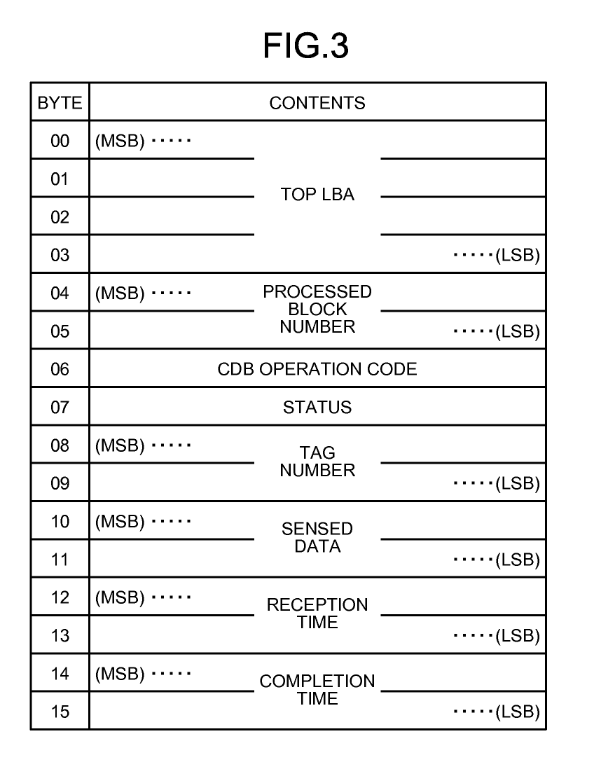

Referring now to FIG. 3, the individual information about the commands in the command log is described. The individual information created for each of the executed commands is formed with 16 bytes in total. The top Logical Block Address (LBA) is the information indicating the top block number accessed by the corresponding command, and is formed with bytes 00 to 03. The processed block number is the information indicating the number of blocks processed by the command, and is formed with bytes 04 and 05. The CDB operation code is the value that is set in accordance with predefined interface standards, and is formed with byte 06. For example, 0x08/0x28 is the information indicating a READ command, 0x0A/0x2A is the information indicating a WRITE command, and 0x2F is the information indicating a VERIFY command. At the status, a value that is set in accordance with the interface rules is registered. The status is the information indicating whether the corresponding command was properly completed, and is formed with byte 07. For example, 0x00 indicates that the command was properly completed, and 0x02 indicates that the command was completed in error at the check condition status.

The TAG number is the information indicating the number that is predefined by the host device as the issuer of the command, and is formed with bytes 08 and 09. The sense data is the information indicating the detailed information about the error that is set when the corresponding command is completed in error. The sense data is formed with bytes 10 and 11. The reception time is the information indicating the time when the corresponding command was received from the host device, and is formed with bytes 12 and 13. The completion time is the information indicating the time when a response to the command was sent to the host device, and is formed with bytes 14 and 15. This individual information is sequentially added to or registered in the command log every time one command is completed.

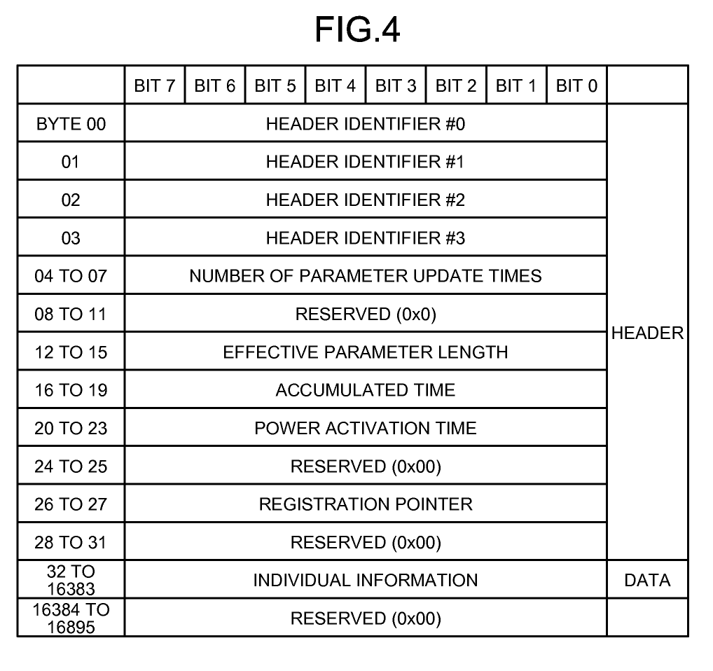

Referring now to FIG. 4, the command log is described. The command log is data that is formed with 16,896 bytes in total. In this data, 1,023 pieces of individual information (or 1,023 commands) can be registered, and up to 18 command logs can be registered in the magnetic storage device 1. Accordingly, up to 18,414 pieces of individual information can be registered in the magnetic storage device 1. When more than 18,414 commands are input, the magnetic storage device 1 overwrites and updates the oldest data, and registers the latest command accompanied by its individual information, with the owned 18 command logs being the units.

Header identifiers #0 to #3 are identification data for discriminating the data sets defined by the magnetic storage device 1 from the up to 18 owned command logs. The header identifiers #0 to #3 are formed with four bytes in total, which are bytes 00 to 03. The number of parameter update times indicates the number of times the corresponding command log has been updated. When the 18 command logs are not enough to register all data, the number of parameter update times is the information indicating the counter that is incremented by 1 every time the oldest data is overwritten and updated. The number of parameter update times is formed with the bytes 04 to 07. The effective parameter length is the information indicating the effective number depending on the number of sets of individual information registered in the corresponding command log, and is formed with bytes 12 to 15. The accumulated time is the information indicating the accumulated time during which the magnetic storage device 1 has been operating since the shipment from the factory. The accumulated time is formed with bytes 16 to 19.

The power activation time is the information indicating the accumulated time during which the magnetic storage device 1 has been operating since the magnetic storage device 1 was activated. The power activation time is formed with bytes 20 to 23. The registration pointer is reference data to be used to register new individual information in the corresponding command log, and interlocks with the effective parameter length. The registration pointer is formed with bytes 26 and 27. The individual information is formed with bytes 32 to 16,383. The areas of bytes 08 to 11, bytes 24 and 25, bytes 28 to 31, and bytes 16,384 to 16,895 are reserved areas (Reserved). The up to 18 sets of history information held by the magnetic storage device 1 are recorded in the system area in the HDD 20. When the magnetic storage device 1 is activated, the device control FW reads the last updated command log from the system area in the HDD 20, and stores the last updated command log into the buffer 19. In this manner, individual information is added every time a command is completed. When the predetermined number (1,023) of commands are registered in the command log, the magnetic storage device 1 stores the command log set in the buffer 19 into the system area in the HDD 20, to sequentially update the command logs. The structures of the individual information and each command log are not limited to the above described structures, and may have any structures as long as the later described determining operation can be performed with the individual information and the command logs.

Next, the operations of the magnetic storage device according to the embodiment are described.

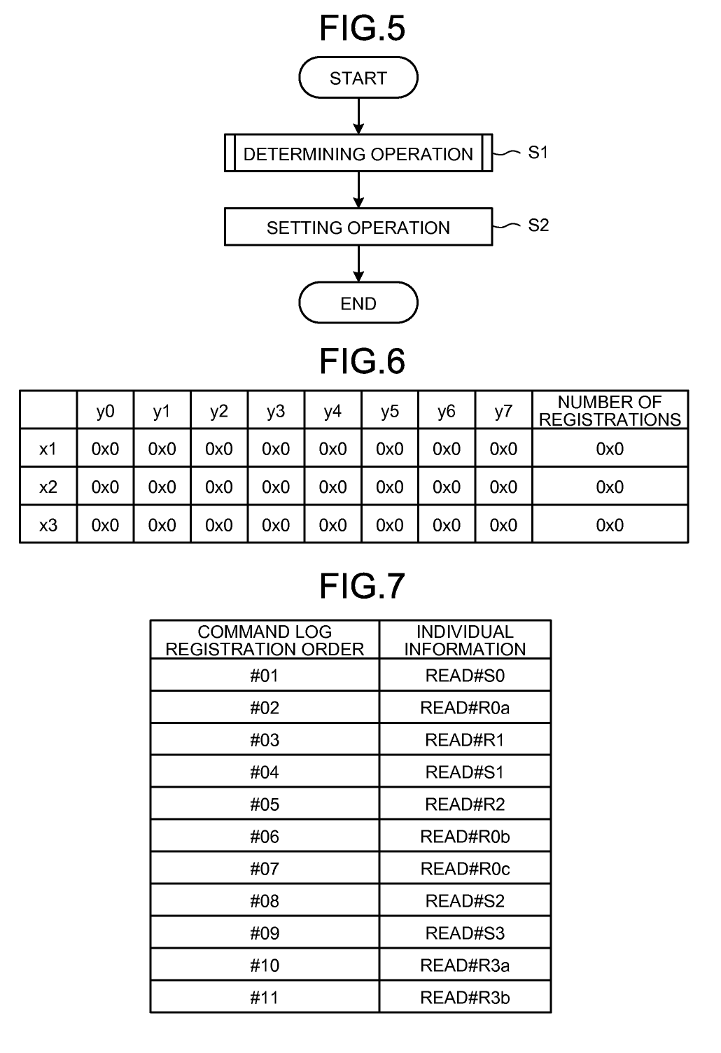

FIG. 5 is a flowchart illustrating a BMS setting operation to be performed in the magnetic storage device according to the embodiment. First, when an instruction to start the BMS setting operation is received, the setting module 101, the extracting module 102, the determiner 103, and the adding processor 104 cooperate with one another to perform a determining operation (S1). After the determining operation, the condition setting module 105 performs a setting operation (S2), and this operation flow then comes to an end. In the determining operation, the individual information about the READ commands in the command logs are sequentially registered in the search table, and, based on the results of the registration, a check is made to determine whether there is a patrolling operation. In the setting operation, the processing conditions for the BMS operation are set on the basis of the results of the determining operation.

First, the determining operation is described with reference to the accompanying drawings. FIG. 6 is a drawing for explaining the search table. FIG. 7 is a drawing illustrating the individual information about the READ commands to be registered in the search table. As illustrated in FIG. 6, the search table is formed with rows x1 to x3, columns y0 to y7, and a registration number column. Here, “0x0” written in the search table indicates a Null state that is an unwritten state. When the search table is initialized, “0x0” is written and registered in the search table. The number of registrations indicates the total number of sets of individual information registered in the columns y0 to y7 in each of the rows x1 to x3. Although this search table is formed with the three rows of the rows x1 to x3 and the eight columns of the columns y0 to y7, the number of rows and the number of columns are not limited to those and may be set at any numbers. In this case, as the number of x rows increases, the accuracy of extraction of a patrolling operation becomes higher. As illustrated in FIG. 7, there are eleven sets of individual information about the READ commands to be registered in the search table. The method of registering the individual information about the eleven READ commands in the table is described below.

The command log registration order indicated in FIG. 7 is formed with the numeric values indicating the sequence of registrations of the READ commands to be registered in the search table. In the command log registration order, #01 represents the oldest command, and #11 represents the newest command. In the search table, #01 is first registered in chronological order. In the individual information illustrated in FIG. 7, READ #S0 to #S3 represent the individual information about sequential READ operation commands issued from the host device on a regular basis. In the embodiment, READ #S0 to #S3 represent a patrolling operation. Meanwhile, READ #R0a to #R0c represent the individual information about sequential READ operation commands issued from the host device irregularly. READ #R1 and #R2 represent the individual information about random access READ commands that do not overlap with the above READ commands. READ #R3a and #R3b represent the individual information about sequential READ operation commands that are irregularly issued from the host device for a block range different from READ #R0a to #R0c. A “block range” is a range containing a predetermined number of blocks in the HDD 20, and a block range is regarded as an access unit (unit block range) in the patrolling operation and the BMS operation. The block range in the BMS operation can be arbitrarily set.

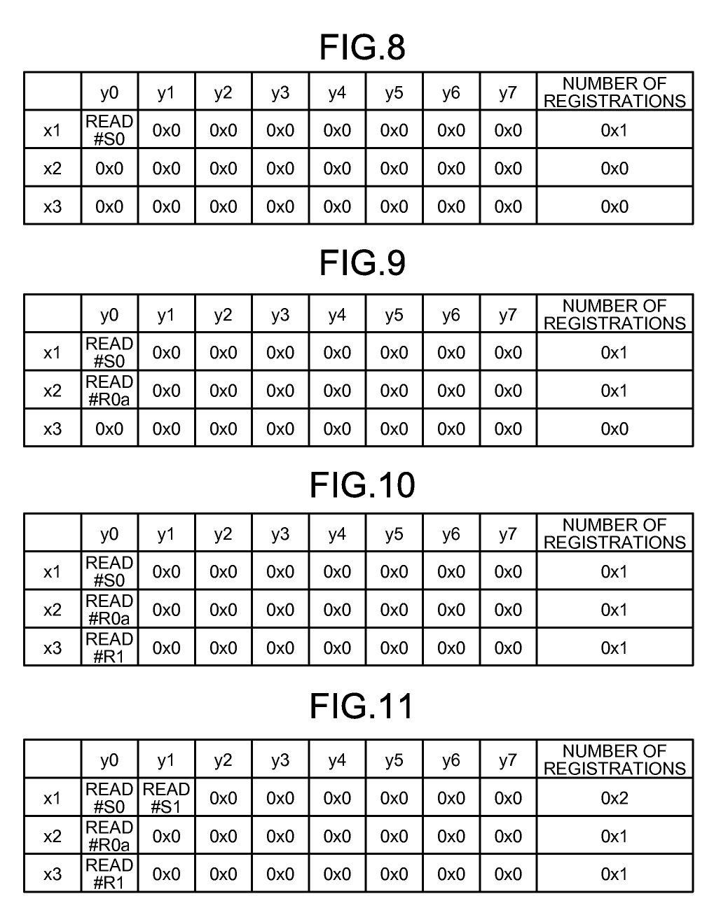

Referring now to FIGS. 8 to 18, the operation to register READ commands in the search table is described. First, READ #S0, which is #01 in the command log registration order, is the subject to be registered in the search table. Since READ #S0 has 0x0 as the number of registrations in all the x rows, the row x1 comes first and is registered at (x1, y0), as illustrated in FIG. 8. At the same time as this registration, the number of registrations in the row x1 is incremented by 1, to become 0x1. A check is then made to determine whether the individual information to be next registered is the individual information about a sequential command, based on the individual information registered at the end of each x row. This check is sequentially made on all pieces of the individual information to be registered. A “sequential command” is a command that is to be registered (hereinafter referred to as the “command to be registered”) and is to access an address that is an address sequentially continuous from the address accessed by a command about registered individual information (hereinafter referred to as a “registered command”). This command as the command to be registered has a start LBA sequentially continuous from the last LBA of a registered command. Accordingly, this check is made based on whether the last LBA+1 of a registered command is equal to the start LBA of the command to be registered. The last LBA is the sum of the top LBA and the number of processed blocks.

Here, READ #R0a is the subject to be next registered, and a check is made to determine whether READ #R0a is a sequential command with respect to the READ #S0. Since READ #R0a is not a sequential command with respect to READ #S0, READ #R0a is registered at (x2, y0) in the row x2, which is the next x row where the number of registrations is 0x0, as illustrated in FIG. 9. At the same time as this registration, the number of registrations in the row x2 is incremented by 1, to become 0x1.

Next, READ #R1 becomes the subject to be registered. Since READ #R1 is not a sequential command with respect to READ S0 and READ #R0a, READ #R1 is registered at (x3, y0) in the row x3, which is the next x row where the number of registrations is 0x0, as illustrated in FIG. 10. At the same time as this registration, the number of registrations in the row x3 is incremented by 1, to become 0x1.

Next, READ #S1 becomes the subject to be registered. Since READ #S1 is a sequential command with respect to READ #S0, READ #S1 is registered at (x1, y1) in the row x1, as illustrated in FIG. 11. At the same time as this registration, the number of registrations in the row x1 is incremented by 1, to become 0x2.

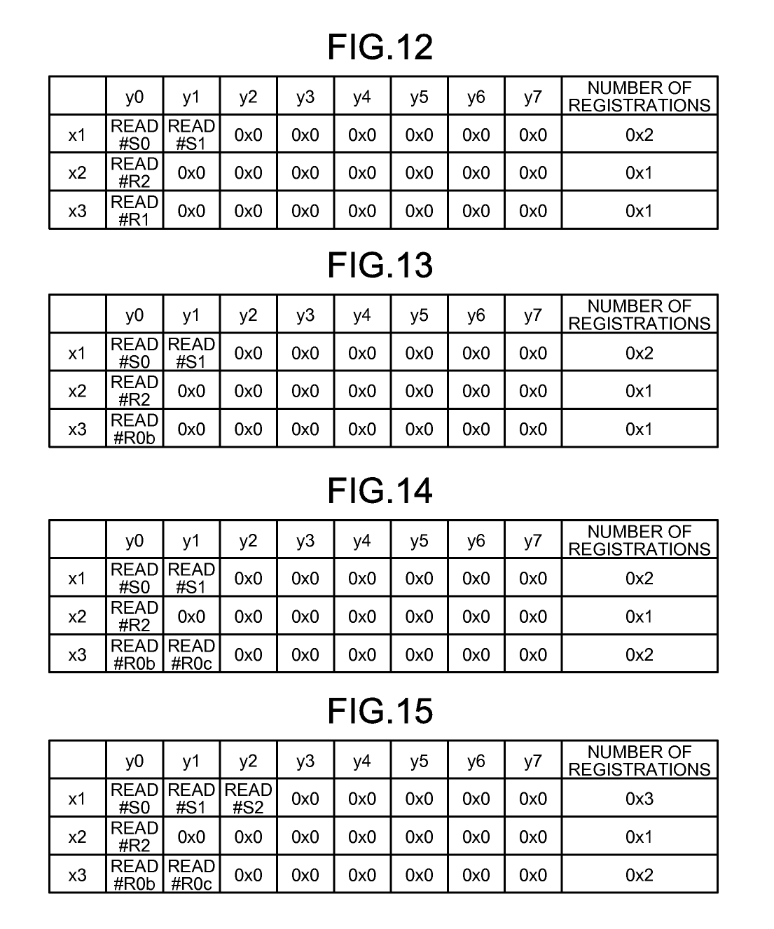

Next, READ #R2 becomes the subject to be registered. Since READ #R2 is not a sequential command with respect to READ S1, READ #R0a, and READ #R1, READ #R2 is written over the existing data and is registered at (x2, y0) in the row x2, which is the x row where the number of registrations is the smallest among the x rows and the oldest individual information about the registered command is stored, as illustrated in FIG. 12. Upon this registration, 0x0 is written into the columns y1 to y7 of the row x2, to initialize the contents.

Next, READ #R0b becomes the subject to be registered. Since READ #R0b is not a sequential command with respect to READ S1, READ #R2, and READ #R1, READ #R0b is written over the existing data and is registered at (x3, y0) in the row x3, as illustrated in FIG. 13. Upon this registration, 0x0 is written into the columns y1 to y7 of the row x3, to initialize the contents.

Next, READ #R0c becomes the subject to be registered. Since READ #R0c is a sequential command with respect to READ #R0b, READ #R0c is registered at (x3, y1) in the row x3, as illustrated in FIG. 14. At the same time as this registration, the number of registrations in the row x3 is incremented by 1, to become 0x2.

Next, READ #S2 becomes the subject to be registered. Since READ #S2 is a sequential command with respect to READ #S1, READ #S2 is registered at (x1, y2) in the row x1, as illustrated in FIG. 15. At the same time as this registration, the number of registrations in the row x1 is incremented by 1, to become 0x3.

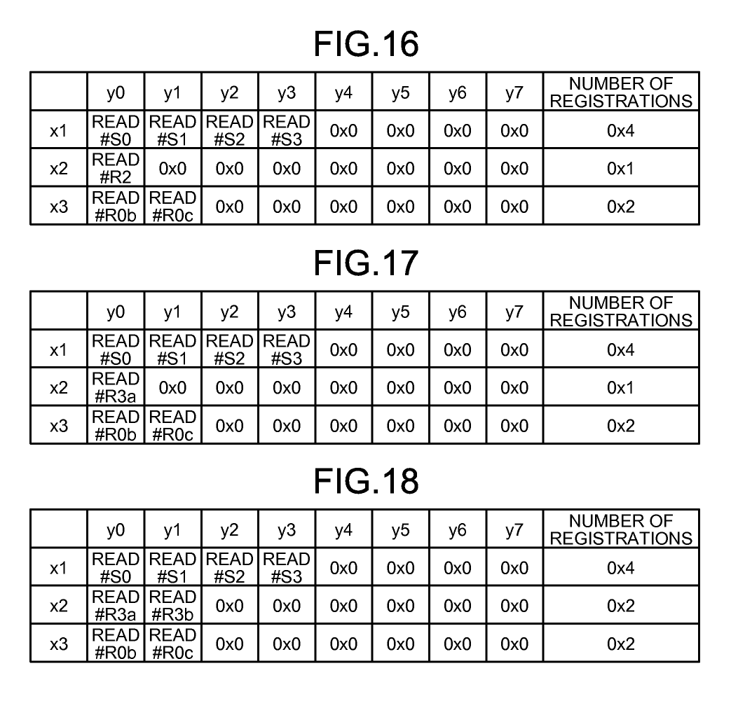

Next, READ #S3 becomes the subject to be registered. Since READ #S3 is a sequential command with respect to READ #S2, READ #S3 is registered at (x1, y3) in the row x1, as illustrated in FIG. 16. At the same time as this registration, the number of registrations in the row x1 is incremented by 1, to become 0x4.

Next, READ #R3a becomes the subject to be registered. Since READ #R3a is not a sequential command with respect to READ S3, READ #R2, and READ #R0c, READ #R3a is written over the existing data and is registered at (x2, y0) in the row x2, as illustrated in FIG. 17. Upon this registration, 0x0 is written into the columns y1 to y7 of the row x2, to initialize the contents.

Next, READ #R3b becomes the subject to be registered. Since READ #R3b is a sequential command with respect to READ #R3a, READ #R3b is registered at (x2, y1) in the row x2, as illustrated in FIG. 18. At the same time as this registration, the number of registrations in the row x2 is incremented by 1, to become 0x2.

By registering the individual information about the READ commands in the search table in the above manner, the search table illustrated in FIG. 18 is completed. Based on this search table, a check is made to determine whether there is a patrolling operation. The number of registrations in each of the x rows is determined. If the number of registrations is 0x1 or less, there is not a patrolling operation by the host device. If there is a row having 0x3 or more as the number of registrations in each of the x rows, each difference in completion time among the registered sets of individual information is calculated, and a check is made to determine whether the commands were issued on a regular basis. In the embodiment, the difference in completion time in the row having 0x2 as the number of registrations is only 1, and therefore, is not taken into consideration. Since there might be no rows having 0x3 or more as the number of registrations, the rows having 0x2 as the number of registrations may be included in the patrolling operation determination. In view of the above, the row x1 is checked, and the differences in completion time among READ #S0 to #S3 are calculated in the embodiment. Since READ #S0 to #S3 are the individual information about the sequential READ operation commands issued by the host device on a regular basis in the embodiment, the differences in completion time are uniform, and a patrolling operation is detected.

Next, the determining operation is described with reference to a flowchart.

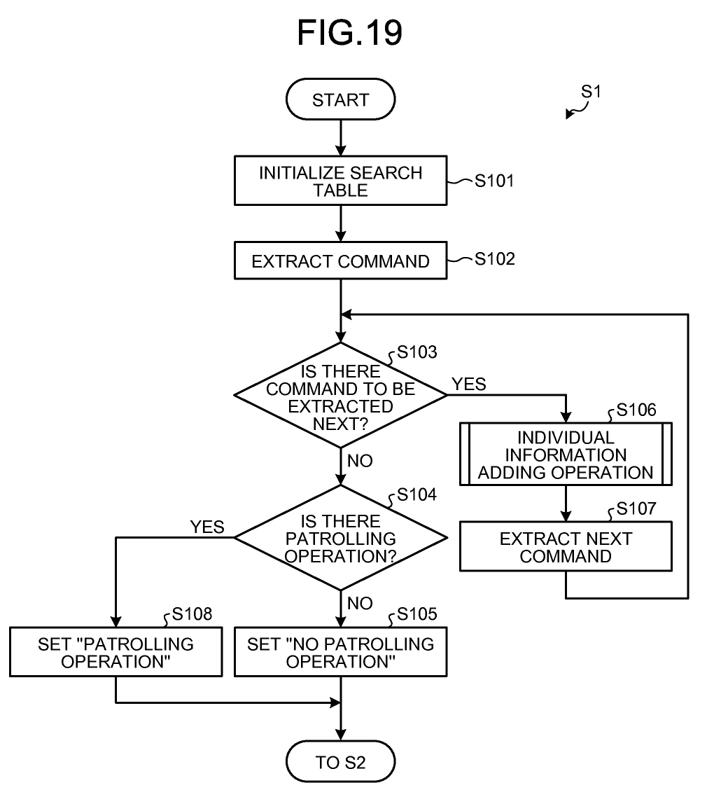

FIG. 19 is a flowchart illustrating the determining operation to be performed in the magnetic storage device according to the embodiment. First, the setting module 101 initializes the search table (S101). Here, the setting module 101 may create a new search table. After the initialization of the search table, the extracting module 102 extracts the oldest READ command from the command log of a unit time, and sets the individual information about the READ command as the subject to be registered in the search table (S102). After the extraction of the command, the determiner 103 determines whether there is a command to be extracted other than the extracted command (S103). If there is no any other command to be extracted (NO at S103), the determiner 103 determines whether there is a patrolling operation (S104). This determination is made based on whether the number of registrations is 0x1 or more in each x row in the search table, and commands are issued at predetermined time intervals. The predetermined time intervals are regular time intervals, for example. The regular time intervals can be arbitrarily set by an external input device or the like. If there is no patrolling operation (NO at S104), “no patrolling operations” is set (S105), and the setting operation of S2 is performed. This setting may be stored in the buffer 19 or the HDD 20.

If there is some other command to be extracted at S103 (YES at S103), the adding processor 104 performs the individual information adding operation (S106), and the extracting module 102 extracts the next command (S107). The operation then returns to S103, and a check is again made to determine whether there is a command to be extracted next. The command adding operation will be described later. If there is a patrolling operation at S104 (YES at S104), “patrolling operation” is set (S108), and the setting operation of S2 is performed. This information may be added to the x rows having commands determined to be patrolling operations. This setting may be stored in the buffer 19 or the HDD 20.

Next, the individual information adding operation is described with reference to a flowchart.

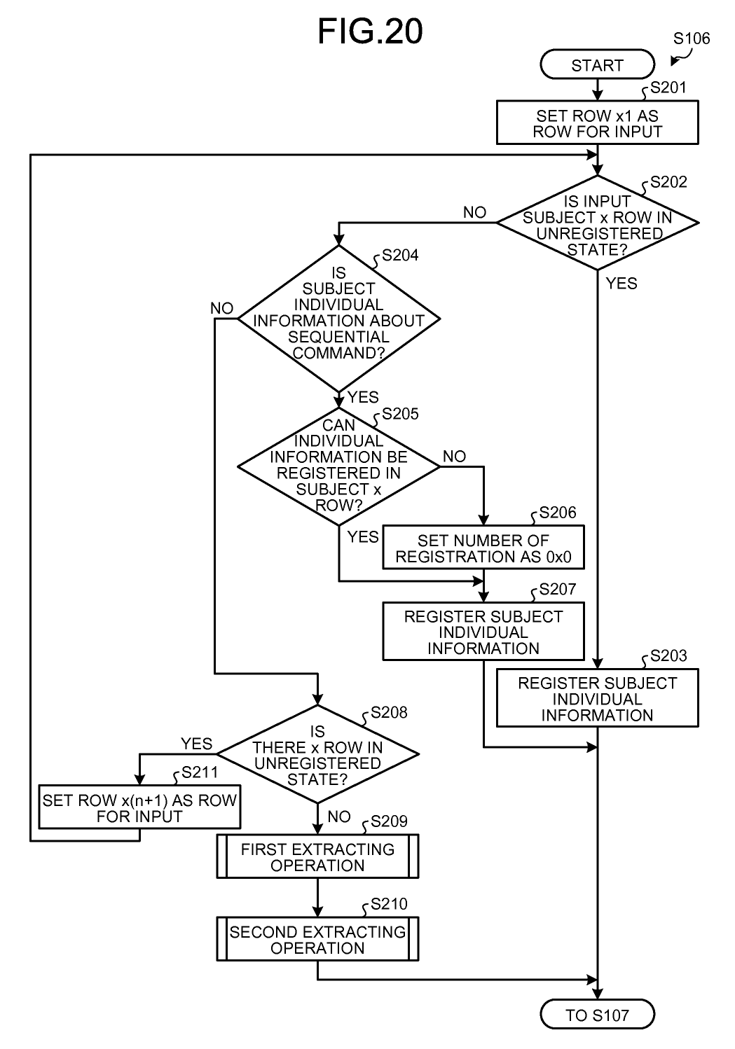

FIG. 20 is a flowchart illustrating the individual information adding operation to be performed in the magnetic storage device according to the embodiment. First, the adding processor 104 sets the row x1 in the search table as the row to which the subject individual information is to be input (S201). After the setting, the adding processor 104 determines whether the search table is in an unregistered state (S202). If the search table is in an unregistered state (YES at S202), the adding processor 104 registers the subject individual information at (x0, y0), and increments the number of registrations in the corresponding x row by 1 (S203). The next command extracting procedure of S107 is then carried out.

If the search table is not in an unregistered state at S202 (NO at S202), the adding processor 104 determines whether the subject individual information is the individual information about a sequential command with respect to the individual information registered at the end of the subject x row (S204). If the subject individual information is the individual information about a sequential command with respect to the registered individual information (YES at S204), the adding processor 104 determines whether the subject individual information can be registered in the subject x row (S205). This determination is made based on whether the number of registrations in the subject x row is equal to the number of registrations (eight in the embodiment) that can be registered in each X row in the search table. If the subject individual information can be registered in the subject x row (YES at S205), the adding processor 104 registers the subject individual information in the y column next to the registered individual information in the subject x row, and adds 1 to the number of registrations in the subject x row (S206). The next command extracting procedure of S107 is then carried out. If the subject individual information cannot be registered in the subject x row at S205 (NO at S205), the adding processor 104 sets 0x0 as the number of registrations in the subject x row (S207). The individual information registering procedure of S206 is then carried out, and the next command extracting procedure of S107 is carried out.

If the subject individual information is not the individual information about a sequential command with respect to the registered individual information at S204 (NO at S204), the adding processor 104 determines whether there is an x row to which the subject individual information is not input (S208). If there is not an x row to which the subject information is not input (NO at S208), the adding processor 104 performs the first extracting operation (S209). After the first extracting operation, the adding processor 104 performs the second extracting operation (S210), and the next command extracting procedure of S107 is carried out. The first extracting operation and the second extracting operation will be described later. If there is an x row to which the subject individual information is not input (YES at S208), the adding processor 104 sets the row x(n+1) as the row to which the subject individual information is to be input (S211). The row x(n+1) is the row having the row number obtained by adding 1 to the row number of the subject x row. The operation then returns to S202, and a check is again made to determine whether the search table is in an unregistered state. Thereafter, the above described procedures are repeated. At S211, the x row having the row number obtained by adding 1 to the row number of the subject x row is set as the row to which the subject individual information is to be input. However, the embodiment is not limited to this, and any row to which individual information has not been written may be set as the row to which the subject individual information is to be input.

Next, the first extracting operation is described with reference to a flowchart.

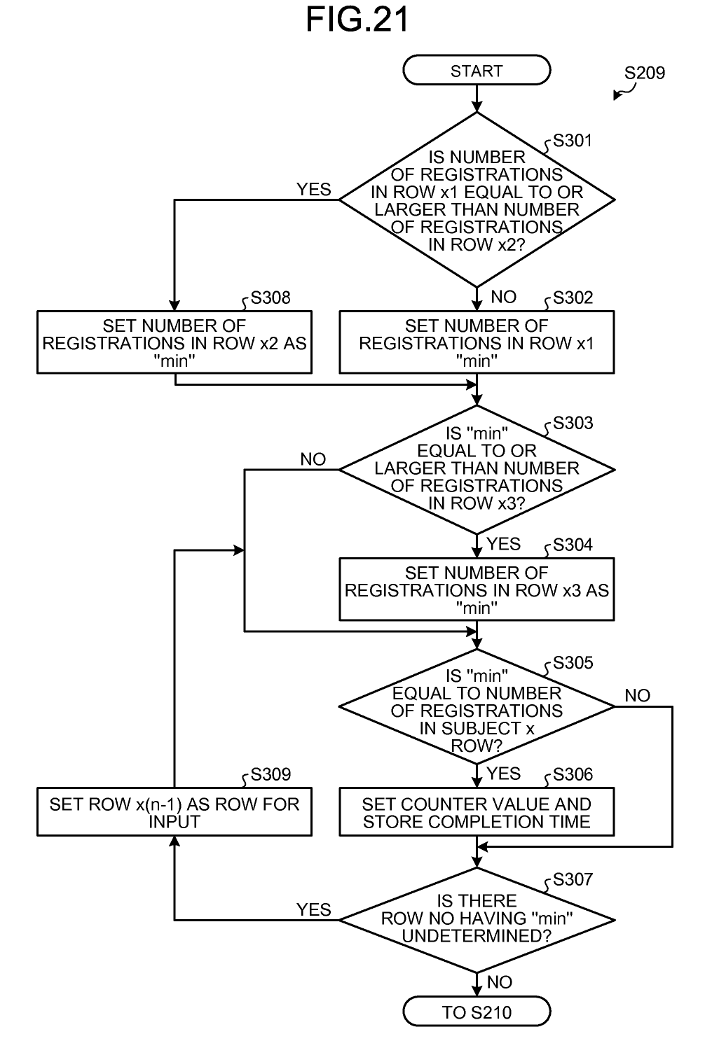

FIG. 21 is a flowchart illustrating the first extracting operation to be performed in the magnetic storage device according to the embodiment. First, the adding processor 104 determines whether the number of registrations in the row x1 is equal to or larger than the number of registrations in the row x2 (S301). If the number of registrations in the row x1 is smaller than the number of registrations in the row x2 (NO at S301), the adding processor 104 sets the number of registrations in the row x1 as the smallest number of registrations (hereinafter referred to as “min”) (S302). After the setting, the adding processor 104 determines whether the value of “min” is equal to or larger than the number of registrations in the row x3 (S303). If the value of min is equal to or larger than the number of registrations in the row x3 (YES at S303), the adding processor 104 sets the number of registrations in the row x3 as “min” (S304).

After the setting, the adding processor 104 determines whether “min” is equal to the number of registrations in the subject x row (S305). If “min” is equal to the number of registrations in the subject x row (YES at S305), the adding processor 104 updates Linecounter that counts the value of “min” or the number in “min” (hereinafter referred to as “the counter value”), and stores the completion time of the READ command as “endtime” (hereinafter referred to as the “storage time”) into the buffer 19 or the HDD 20 in accordance with the individual information last registered in the x row having “min” (S306). The number in “min” in the counter value is counted from 0x0. When the number in “min” is “1”, the counter illustrates 0x1, and, when the number in “min” is “2”, the counter illustrates 0x2. After the storing, the adding processor 104 determines whether there is an x row having the number of registrations that has not been compared with “min” (S307). If there is not an x row having the number of registrations that has not been compared with “min” (NO at S307), the second extracting operation of S210 is performed.

If the number of registrations in the row x1 is equal to or larger than the number of registrations in the row x2 at S301 (YES at S301), the adding processor 104 sets the registration number in the row x2 as “min” (S308), and a check is made to determine whether the value of “min” is equal to or larger than the number of registrations in the row x3 at S303. If the value of “min” is smaller than the number of registrations in the row x3 at S303 (NO at S303), a check is made to determine whether “min” is equal to the number of registrations in the subject x row at S305. If “min” is not equal to the number of registrations in the subject x row at S305 (NO at S305), a check is made to determine whether there is an x row having the number of registrations that has not been compared with “min” at S307. If there is an x row having the number of registrations that has not been compared with “min” at S307 (YES at S307), the adding processor 104 sets the row x (n−1) as the row to which the subject individual information is to be input (S309). The row x (n−1) has the row number set by subtracting “1” from the row number of the subject x row. A check is again made to determine whether “min” is equal to the number of registrations in the subject x row at S305. At S309, the x row having the row number set by subtracting “1” from the row number of the subject x row is set as the row to which the individual information is to be input. However, the embodiment is not limited to that, and any row to which the subject individual information has not been input may be set as the row to which the subject individual information is to be input.

Next, the second extracting operation will be described with reference to a flowchart.

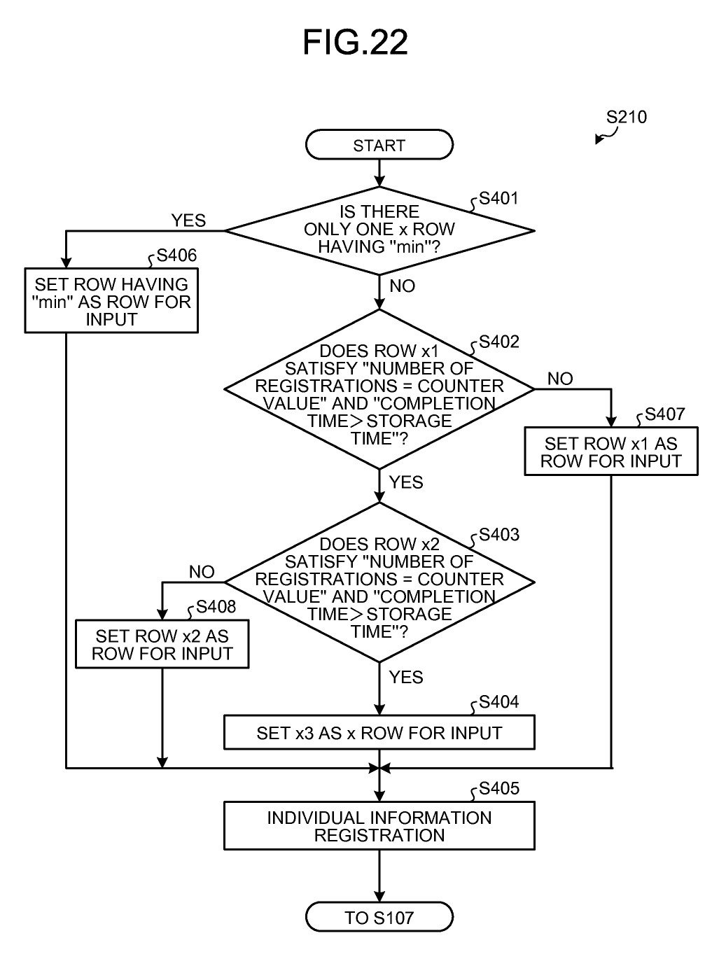

FIG. 22 is a flowchart illustrating the second extracting operation to be performed in the magnetic storage device according to the embodiment. First, the adding processor 104 determines whether there is only one x row having “min”, based on the counter value (S401). If there is more than one row having “min” (NO at S401), the adding processor 104 determines whether the row x1 satisfies the conditions “the number of registrations is equal to the counter value” and “the completion time is longer than the storage time”. More specifically, the adding processor 104 determines whether the number of registrations in the row x1 is equal to “min” in the counter value, and the completion time of the READ command in the individual information last registered in the row x1 is longer than the storage time (S402).

If the row x1 satisfies the conditions “the number of registrations is equal to the counter value” and the completion time is longer than the storage time (YES at S402), the adding processor 104 determines whether the row x2 satisfies the conditions “the number of registrations is equal to the counter value” and “the completion time is longer than the storage time” (S403). More specifically, the adding processor 104 determines whether the number of registrations in the row x2 is equal to “min” in the counter value, and the completion time of the READ command in the individual information last registered in the row x2 is longer than the storage time. If the row x2 satisfies the conditions “the number of registrations is equal to the counter value” and “the completion time is longer than the storage time” (YES at S403), the adding processor 104 sets the row x3 as the row to which the subject individual information is to be input (S404). After the setting, the adding processor 104 registers the individual information in the top column y0 in the subject x row, and writes 0x0 in each of the other columns y1 to y7, to make the number of registrations in the subject x row 0x1 (S405, registering step). The next command extracting procedure of S107 is then carried out.

If there is only one x row having “min” at S401 (YES at S401), the adding processor 104 sets the x row having “min” as the row to which the subject individual information is to be input (S406). The command registering procedure of S405 is then carried out. If the row x1 does not satisfy the conditions “the number of registrations is equal to the counter value” and the completion time is longer than the storage time at S402 (NO at S402), the adding processor 104 sets the row x1 as the row to which the subject individual information is to be input (S407), and the individual information registering procedure of S405 is carried out. If the row x2 does not satisfy the conditions “the number of registrations is equal to the counter value” and the completion time is longer than the storage time at S403 (NO at S403), the adding processor 104 sets the row x2 as the row to which the subject individual information is to be input (S408), and the individual information registering procedure of S405 is carried out.

Next, the setting operation is described.

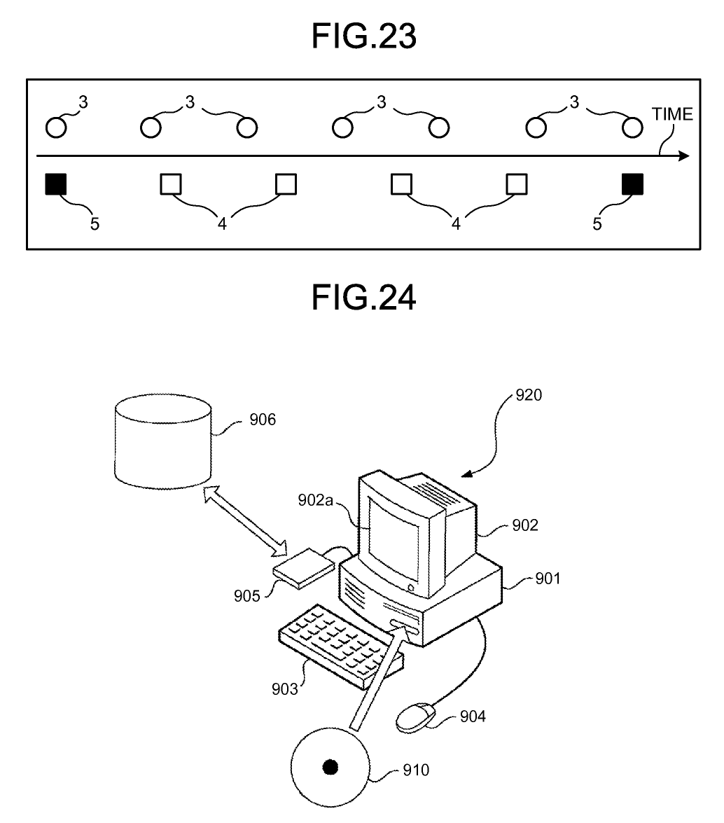

After the determining operation, the condition setting module 105 extracts an issuance time interval that is the time interval after which a patrolling operation is issued, based on the reception time in each of the sets of individual information determined to be related to patrolling operations. The condition setting module 105 then compares the issuance time interval with the execution time interval with respect to the BMS operation to be next performed. If the patrolling operation to be next performed and the BMS operation to be next performed overlap with each other, the overlapping BMS operation is disabled. After the command of a patrolling operation is completed, the processing conditions for a BMS operation may be set so that BMS is performed after a predetermined interval. FIG. 23 is a diagram for explaining the BMS operation for which the processing conditions are set through the setting operation. In FIG. 23, each “3” represents a patrolling operation, and each “4” represents a BMS operation. Each “5” represents a disabled BMS operation. The arrow in FIG. 23 represents the elapsed time. As illustrated in FIG. 23, the condition setting module 105 sets the processing conditions for BMS operations, so that any BMS operation overlapping with a patrolling operation 3 in the same time slot is disabled. Through this setting, overlapping between a patrolling operation and a BMS operation can be prevented. Also, a response to a patrolling operation command can be sent to the host device without delay.

The setting operation in the embodiment is performed so that a patrolling operation and a BMS operation do not overlap. However, the setting operation may be performed so that the start LBA (a first start address) of a patrolling operation and the start LBA (a second start address) of a BMS operation do not overlap. In this case, the condition setting module 105 extracts the issuance time interval of patrolling operations, based on the reception time in each sets of individual information determined to be related to patrolling operations. The condition setting module 105 then determines the start LBA of the patrolling operation to be next issued, from the last LBA in the individual information last registered in the search table among the individual information determined to be related to patrolling operations. The condition setting module 105 then compares this start LBA with the start LBA of the BMS operation to be next performed.

If there is an overlap between the start LBA of the patrolling operation to be next performed and the start LBA of the BMS operation to be next performed, the condition setting module 105 disables the BMS operation to be next performed, and sets conditions so that the BMS operation to be performed thereafter starts from the last LBA of the patrolling operation last performed. The BMS operation may have a start LBA that is the LBA formed by adding “1” to the last LBA of the patrolling operation. Here, the frequency of BMS operation nullification varies depending on the issuance time interval of patrolling operations and the execution time interval of BMS operations. As the issuance time interval of patrolling operations becomes shorter, the frequency of BMS operation nullification becomes higher. As the issuance time interval of patrolling operations becomes longer, the frequency of BMS operation nullification becomes lower. As a result, the progress of BMS operations becomes faster than that of patrolling operations.

In the setting operation according to the embodiment, the processing conditions for BMS operations may also be set so that the block range to be accessed by patrolling operations is incorporated into the BMS operations. In this case, the condition setting module 105 extracts the issuance time interval of patrolling operations, based on the reception time in each of the sets of individual information determined to be related to patrolling operations. The condition setting module 105 then determines the start address of the patrolling operation to be next issued, from the last LBA in the individual information last registered in the search table among the sets of individual information determined to be related to patrolling operations.

If the issuance time interval of patrolling operations is shorter than a predetermined interval, the condition setting module 105 performs setting so that the address at which access is started in the BMS operation falls within a block range precedential to the block range to be accessed by the patrolling operation to be next performed. The predetermined interval may be arbitrarily set by an external input device or the like. On the other hand, if the issuance time interval of patrolling operations is longer than the predetermined interval, the condition setting module 105 performs setting so that the block range in the BMS operation to be next performed is the same as the block range in the patrolling operation to be next performed. In addition to this setting, the condition setting module 105 performs setting so that any BMS operation having a block range overlapping that of a patrolling operation is disabled. When the next BMS operation is performed, the overlapping between the block range of the BMS operation and the block range of the patrolling operation becomes larger. However, when there is an overlap in the block range, the BMS operation is disabled. Accordingly, the frequency of BMS operations can be made lower.

In accordance with the embodiment, a predetermined command is extracted from the command log, and the individual information and command about the patrolling operation are determined based on the individual information about the extracted command. Accordingly, the processing conditions for BMS operations can be set. Since the processing conditions for BMS operations can be set, unnecessary BMS operations can be eliminated, and BMS operations can be efficiently performed. Also, since patrolling operations and BMS operations interlock with each other, the BMS operations can be completed in a shorter period of time than conventional BMS operations. Efficient execution of BMS operations leads to the reduction of time required to access the HDD 20. Accordingly, the usage time of the components of the HDD 20 and each recording disk medium and the head can be reduced, and degradation of the magnetic storage device 1 can be restricted.

The embodiment can be applied to the following computer system. FIG. 24 is a schematic view illustrating the computer system according to the embodiment. A computer system 920 illustrated in FIG. 24 comprises a main body 901 housing a CPU, a disk drive, and the likes; a display 902 that displays an image in accordance with an instruction from the main body 901; a keyboard 903 for inputting various kinds of information to the computer system 920; a mouse 904 that designates a position on a display screen 902a of the display 902; and a communication device 905 that accesses an external database or the like and downloads a program or the like from another computer system. The communication device 905 may be a network communication card, a modem, or the like. The computer system 920 is the magnetic storage device 1 of the above embodiment.

The program for causing the computer system forming the magnetic storage device 1 to carry out the steps can be provided as a processing condition setting program. This program is stored in a recording medium that can be read by the computer system, so that the program can be executed by the computer system forming the magnetic storage device 1. The program for carrying out the above described steps may be stored in a portable recording medium such as a disk 910 or the like, or may be downloaded from a recording medium 906 of another computer system through the communication device 905. Also, the processing condition setting program (processing condition setting software) for providing at least a processing condition setting function to the computer system 920 is input to and is compiled in the computer system 920. This program causes the computer system 920 to operate as the magnetic storage device 1 having the processing condition setting function.

This program may also be stored in a computer-readable recording medium such as the disk 910 or the like. Here, examples of recording media that can be read by the computer system 920 comprise an internal storage device such as a ROM or RAM installed in the computer, a portable storage medium such as the disk 910, a flexible disk, a DVD disk, a magneto-optic disk, or an IC card, a database storing computer programs, another computer system and its database, and any other various recording media that can be accessed by a computer system connected via a communication module such as the communication device 905.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic storage device, comprising:
a first storage module configured to store historical information about each of one or more operation commands originating from an external device for the magnetic storage device, wherein the historical information about each operation command comprises at least the execution times and access address information;
a verification processing detector configured to detect a first set of operation commands corresponding to a first verification operation based on the historical information; and
a processing condition setting module configured to set processing conditions for one or more of a second set of operation commands corresponding to a second verification operation, wherein the processing conditions are set based at least in part on the historical information, and wherein the operation commands corresponding to the second verification operation verify data in the first storage module.

2. The magnetic storage device of claim 1, wherein the verification processing detector comprises:
an address determiner configured to determine whether at least some of the access addresses associate with operation commands in the historical information are consecutive;
a time interval determiner configured to determine, based at least in part on the execution times associated with operations commands in the historical information, whether any operation commands accessing consecutive addresses are executed at predetermined time intervals; and
an operation command determiner configured to determine whether the operation commands determined to access consecutive addresses and determined to execute at predetermined time intervals correspond to the first verification operation.

3. The magnetic storage device of claim 1, wherein the processing condition setting module is configured to set the processing conditions for some or all of the second set of operation commands corresponding to the second verification operation so that a next performance of an operation command in the first set of operation commands and the execution time of the operation commands in the second set of operations do not overlap with each other.

4. The magnetic storage device of claim 1, wherein the processing condition setting module is configured to:
determine whether a first access address associated with a first operation command in the first set overlaps with a second access address associated with a second operation command in the second set, wherein no other operation command in the first set is scheduled to run before the first operation command runs and wherein no other operation command in the second set is scheduled to run before the second operation command runs; and
set processing conditions for the operation commands in the second set if the first access address and the second access address overlap, wherein setting processing conditions comprises:
disabling the second operation command, and
setting an access address associated with a third operation command to an address subsequent to a last access address associated with a fourth operation command, wherein the third operation command is in the second set and no other operation command in the second set was scheduled to run after the second operation command and before the third operation command, wherein the fourth operation command is in the first set, and wherein no operation commands in the first or second sets are scheduled to be performed after the performance of the fourth operation command and before the performance of the third operation command.

5. The magnetic storage device of claim 1, wherein
the operation commands corresponding to the first verification operation and the operation commands corresponding to the second verification operation each access the first storage module by a unit block range of a predetermined number of blocks of the first storage module;
the processing condition setting module is configured to:
set the block range to be accessed by the operation commands corresponding to the second verification operation to be precedential to the block range to be accessed by the operation commands corresponding to the first verification operation, if an interval between execution times of two consecutive operation commands in the first set is shorter than a predetermined interval, and
set the block range to be accessed by the operation commands corresponding to the second verification operation to be the same as the block range to be accessed by the operation commands corresponding to the first verification operation, if an interval between execution times of two consecutive operation commands in the first set is longer than the predetermined time interval.

6. The magnetic storage device of claim 2, wherein
the verification processing determiner further comprises an operation command extracting module configured to extract two or more predetermined operation commands from the historical information, and
the address determiner is configured to determine whether any access address associated with the two or more operation commands extracted by the command extracting module are consecutive.

7. The magnetic storage device of claim 2, wherein the address determiner comprises:
a table setting module configured to set a table;
a registration module configured to sequentially register at least some of the historical information about the operation commands into the table in accordance with a predetermined rule, wherein the at least some of the historical information includes at least some access addresses; and
a table determiner configured to determine whether the registered access addresses in the table are consecutive addresses.

8. The magnetic storage device of claim 2, wherein the operation command determiner is configured to determine that one of a plurality of groups of operation commands is the first verification operation, wherein each group is comprised of operation commands, the operation commands in the groups are executed at predetermined time intervals, and the one group is the group of operation commands having a longest time interval.

9. The magnetic storage device according to claim 1, wherein the historical information comprises information about operation commands executed in a predetermined period of time.

10. A method for setting processing conditions for a magnetic storage device, the method comprising:
detecting whether there is a first plurality of operation commands corresponding to a first verification operation, the detection based at least on a first plurality of sets of information, each set of information comprising information about an operation command for the magnetic storage device, wherein each set of information comprises execution times and accessed address information associated with the operation command, wherein the sets of information are stored in a first storage module, wherein any operation commands in the first plurality of operation commands originate from an external device, and wherein the first plurality of operation commands comprises at least a subset of operation commands each associated with a set of information; and
setting processing conditions for a second plurality of operation commands corresponding to a second verification operation to verify data stored in the first storage module, the processing conditions based at least on a second plurality of sets of information, each set in the second plurality of sets comprising information about an operation command in the first plurality of operation commands corresponding to the first verifying operation.

11. The method of claim 10, wherein detecting comprises:
determining whether consecutive addresses in the first storage module were accessed by operation commands associated with sets of information, based at least in part on the accessed address information in the sets of information;
determining whether any operation commands accessing consecutive addresses are executed at predetermined time intervals, based at least in part on the execution times in the sets of information; and
determining that any operation commands accessing consecutive addresses and executing at predetermined time intervals correspond to the first verification operation.

12. The method of claim 10, wherein setting processing conditions for a second plurality of operation commands corresponding to a second verification operation comprises setting execution times for one or more operation commands in the second plurality based at least in part on the sets of information associated with the operation commands in the first plurality, wherein each operation command in the second plurality of operation commands is set to begin and complete execution before a next execution of the operation commands in the first plurality or each does so after a next execution of the operation commands in the first plurality.

13. The method of claim 10, wherein setting processing conditions comprises:
determining whether a first access address associated with a first operation command in the first plurality overlaps with a second access address associated with a second operation command in the second plurality, wherein no other operation command in the first plurality is scheduled to run before the first operation command runs and wherein no other operation command in the second plurality is scheduled to run before the second operation command runs; and
after determining that the first access address and the second access address overlap,
disabling the second operation command, and
setting an access address associated with a third operation command to an address subsequent to a last access address associated with a fourth operation command, wherein the third operation command is in the second plurality and no other operation command in the second plurality was scheduled to run after the second operation command and before the third operation command, wherein the fourth operation command is in the first plurality, and wherein no operation commands in the first or second pluralities are scheduled to be performed after the performance of the fourth operation command and before the performance of the third operation command.

14. The method of claim 10, wherein setting processing conditions comprises:
setting a block range to be accessed by the operation commands corresponding to the second verification operation to be precedential to the block range to be accessed by the operation commands corresponding to the first verification operation, if an interval between execution times of two consecutive operation commands in the first plurality is shorter than a predetermined interval, and
setting a block range to be accessed by the operation commands corresponding to the second verification operation to be the same as the block range to be accessed by the operation commands corresponding to the first verification operation, if an interval between execution times of two consecutive operation commands in the first plurality is longer than the predetermined time interval,
wherein the operation commands corresponding to the first verification operation and the operation commands corresponding to the second verification operation each access the first storage module by a unit block range of a predetermined number of blocks of the first storage module.

15. The method of claim 11, wherein the first determining comprises:
setting a table;
sequentially registering at least the address access information from the sets of information about the operation commands stored in the first storage module into the set table in accordance with a predetermined rule; and
determining whether addresses in the first storage module accessed by the operation commands are consecutive addresses, based on the information registered in the table.

16. Computer readable media including programmed instructions for setting processing conditions for a magnetic storage device, that, when executed by a computer, cause the computer to perform the following steps:
detecting whether there are a plurality of operation commands corresponding to a first verifying operation, based on a plurality of sets of information about the operation commands for the magnetic storage device from an external device, wherein the sets of information comprise execution times and sets of accessed address information, wherein the sets of information are stored in a first storage module as history information; and
setting processing conditions for a second verifying operation to verify data stored in the first storage module, wherein the processing conditions are set if a plurality of operation commands corresponding to a first verifying operation is detected and wherein the setting is based at least in part on the sets of information about the operation commands corresponding to the first verifying operation.

17. The computer readable media of claim 16, wherein detecting comprises:
determining whether consecutive addresses in the first storage module were accessed by the operation commands associated with sets of information, based at least in part on the accessed address information in the sets of information;
determining whether any operation commands accessing consecutive addresses are executed at predetermined time intervals, based at least in part on the execution times in the sets of information; and
determining that the operation commands accessing consecutive addresses and executing at predetermined time intervals correspond to the first verifying operation.

18. The computer readable media of claim 16, wherein setting processing conditions comprises setting execution times for one or more operation commands in a second plurality of operation commands corresponding to a second verifying operation based at least in part on the sets of information associated with the operation commands in the first plurality, wherein each operation command in the second plurality of operation commands is set to begin and complete execution before a next execution of the operation commands in the first plurality or each does so after a next execution of the operation commands in the first plurality.

19. The computer readable media of claim 16, wherein setting processing conditions comprises:
determining whether a first access address associated with a first operation command in the first plurality overlaps with a second access address associated with a second operation command in the second plurality, wherein no other operation command in the first plurality is scheduled to run before the first operation command runs and wherein no other operation command in the second plurality is scheduled to run before the second operation command runs; and
after determining that the first access address and the second access address overlap,
disabling the second operation command, and
setting an access address associated with a third operation command to an address subsequent to a last access address associated with a fourth operation command, wherein the third operation command is in the second plurality and no other operation command in the second plurality was scheduled to run after the second operation command and before the third operation command, wherein the fourth operation command is in the first plurality, and wherein no operation commands in the first or second pluralities are scheduled to be performed after the performance of the fourth operation command and before the performance of the third operation command.

20. The product of claim 16, wherein
the first verifying operation and the second verifying operation each make access to the first storage module by a unit block range of a predetermined number of blocks of the first storage module;
the setting comprises determining whether an interval between each two execution times of the operation commands corresponding to the first verifying operation is shorter than a predetermined interval, and when the interval is shorter than the predetermined interval, the setting comprises performing setting so that the block range to be accessed by the second verifying operation is a block range precedential to the block range to be verified by the first verifying operation, and when the interval is longer than the predetermined time interval, the setting comprises performing setting so that the block range to be accessed by the second verifying operation is the same as the block range to be verified by the first verifying operation.
